(19) United States
(12) Patent Application Publication
(10) Pub. No.: US 2014/0292747 A1
(43) Pub. Date: Oct. 2, 2014

(54) METHOD OF GENERATING 3D GRAPHIC DATA FOR MOBILE DEVICE WITH IMPROVED USABILITY AND APPLICATION DEVELOPMENT ENVIRONMENT USING THE METHOD

(71) Applicant: Samsung Electronics Co., Ltd., Suwon-si (KR)

(72) Inventor: Choong Hun LEE, Yongin-si (KR)

(73) Assignee: Samsung Electronics Co., Ltd., Suwon-si (KR)

(21) Appl. No.: 14/058,820

(22) Filed: Oct. 21, 2013

(30) Foreign Application Priority Data
Apr. 2, 2013 (KR) 10-2013-0035897

(51) Int. Cl. G06T 15/00

(52) U.S. Cl. CPC G06T 15/00
USPC 345/419

(57) ABSTRACT

A 3D graphic data generation method for a mobile device with improved usability and an application development environment using the method include a shader integrated development environment (IDE) which loads a plurality of 3D objects generated based on an authoring tool, sorts the plurality of 3D objects according to depths from a camera, and provides the plurality of 3D objects being sorted to a 3D application which is driven in the mobile device.

### CROSS-REFERENCE TO RELATED APPLICATIONS

This application claims the priority benefit of Korean Patent Application No. 10-2013-0035897, filed on Apr. 2, 2013, in the Korean Intellectual Property Office, the disclosure of which is incorporated herein by reference.

### BACKGROUND

1. Field

One or more example embodiments disclosed herein relate to a method of generating 3-dimensional (3D) graphic data for a mobile device with improved usability, and an application development environment using the method.

2. Description of the Related Art

To provide a user with a 3-dimensional (3D) graphic, a mobile device may perform rendering using 3D graphic data. The rendering refers to a process of adding reality to a computer graphic by applying 3D texture such as a shadow, a color, a density change, and the like. Further, 3D rendering may refer to a process of producing an image by applying 3D geometric information and external information such as a light source, a position, and a color, to a 3D image.

In general, 3D graphic data, to which rendering is to be applied, may be generated using an authoring tool and an integrated development environment (IDE) for a shader.

Recently, research is being conducted to obtain more effective production of 3D graphic data.

### SUMMARY

The foregoing and/or other aspects may be achieved by providing a method for generating 3-dimensional (3D) graphic data of a shader integrated development environment (IDE), the method including loading a plurality of 3D objects generated based on an authoring tool, sorting the plurality of 3D objects according to depths from a camera, and providing the sorted plurality of 3D objects to a 3D application which is driven in a mobile device.

The loading of the plurality of 3D objects may include loading a scene file stored in the shader IDE, and identifying data elements of the plurality of 3D objects from the scene file.

The sorting of the plurality of 3D objects may include calculating object vertex medians of the plurality of 3D objects based on the data elements, and associating object identifiers (IDs) of the plurality of 3D objects included in the data elements and data structures with the object vertex medians.

The method may further include determining whether camera routes of the plurality of 3D objects are set, and arranging the plurality of 3D objects according to depths from a camera depending on whether the camera routes are set.

When the camera routes of the plurality of 3D objects are set, the arranging of the plurality of 3D objects may include identifying camera positions of the plurality of 3D objects, calculating model views (MV) of the plurality of 3D objects based on the camera positions, extracting information on the depths from the camera of the plurality of 3D objects, using the object vertex medians, the camera positions, and the MVs being associated, and allocating the 3D objects to a queue according to the depths from the camera using the information on the depths.

The providing of the sorted plurality of 3D objects may include storing information on the queue to which the plurality of 3D objects are allocated to a binary file, and transmitting the binary file to the 3D application.

The foregoing and/or other aspects may also be achieved by providing a method of generating 3D graphic data of a 3D application driven in a mobile device, the method including receiving a plurality of 3D objects sorted according to depths from a camera, from a shader integrated development environment (IDE), allocating the plurality of 3D objects to a render queue using information on the depths from the camera, and rendering the plurality of 3D objects using the render queue.

The receiving of the plurality of 3D objects may include receiving a binary file that includes information on the depths from the camera, from the shader IDE, and extracting information on a queue to which the plurality of 3D objects are allocated according to the depths, from the binary file.

The binary file may further include information on the plurality of 3D objects, data elements of the plurality of 3D objects, and shader information.

The rendering may further include initializing an embedded graphic library; receiving texture information and shader information, and rendering the plurality of 3D objects using the plurality of 3D objects, data elements of the plurality of 3D objects, the texture information, and the shader information.

The foregoing and/or other aspects may also be achieved by providing a method of generating a 3D graphic data of an authoring tool, the method including generating a material file that includes material information, uniform information, and texture information of a plurality of 3D objects, and generating a shader file using at least one of lighting information and the texture information of the plurality of 3D objects.

The generating of the shader file may further include generating the shader file by combining preset lighting information and texture shader information of the plurality of 3D objects.

The generating of the shader file may further include generating the shader file using simple color shader information.

The generating of the shader may further include generating the shader file using lighting color shader information.

The method may further include providing the material file and the shader file to the shader IDE.

The method may further include providing the material file and the shader file to a 3D application driven in the mobile device.

The foregoing and/or other aspects may also be achieved by providing a shader IDE including an object loader to load a plurality of 3D objects generated based on an authoring tool, a depth sorter to sort the plurality of 3D objects according to depths from a camera, and an object provider to provide the sorted plurality of 3D objects to a 3D application which is driven in a mobile device.

The foregoing and/or other aspects may also be achieved by providing a 3D application including an object receiver to receive a plurality of 3D objects sorted according to depths from a camera from a shader IDE; a render queue allocator to allocate the plurality of 3D objects to a render queue using information on the depths of the plurality of 3D objects from the camera, and a renderer to render the plurality of 3D objects using the render queue.

The foregoing and/or other aspects may also be achieved by providing an authoring tool including a material file generator to generate a material file including material information, uniform information, and texture information of a plurality of 3D objects, and a shader file generator to generate a shader file using at least one of lighting information and the texture information of the plurality of 3D objects.

The foregoing and/or other aspects may also be achieved by a method of generating 3-dimensional (3D) graphic data of a 3D application driven in a mobile device, the method including: receiving a plurality of 3D objects and depth information of the plurality of 3D objects, from a shader integrated development environment (IDE); receiving, from at least one of the shader IDE and an authoring tool, a shader file including at least one of color impression and pattern information of the plurality of 3D objects; receiving, from at least one of the shader IDE and the authoring tool, a material file including at least one of material information, uniform information, and texture information of the plurality of 3D objects; and rendering the plurality of 3D objects in a predetermined order based on the depth information of the plurality of 3D objects, using information from the shader file and the material file.

For example, the material file may be received from the authoring tool and the shader file may be received from the shader IDE. For example, the material file and the shader file may be received from the shader IDE.

Additional aspects, features, and/or advantages of example embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments, taken in conjunction with the accompanying drawings of which:

FIG. 1 illustrates an authoring tool, a shader integrated development environment (IDE), and a 3-dimensional (3D) application, according to example embodiments;

FIG. 2 illustrates an operational flow of a method of generating 3D graphic data of a shader IDE, according to example embodiments;

FIG. 3 illustrates an operational flow of a method of generating 3D graphic data of a 3D application, according to example embodiments;

FIG. 4 illustrates an operational flow of a method of generating 3D graphic data of an authoring tool, according to example embodiments;

FIG. 5 illustrates a shader IDE according to example embodiments; and

FIG. 6 illustrates an authoring tool according to example embodiments.

### DETAILED DESCRIPTION

Reference will now be made in detail to example embodiments, examples of which are illustrated in the accompanying drawings, wherein like reference numerals refer to like elements throughout. Example embodiments are described below to explain the present disclosure by referring to the figures.

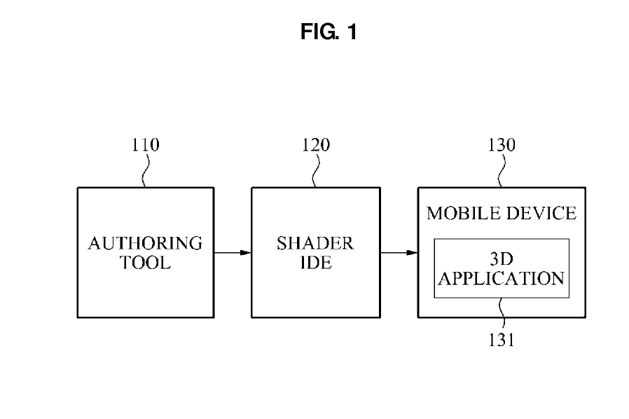

FIG. 1 illustrates an authoring tool 110, a shader integrated development environment (IDE) 120, and a 3-dimensional (3D) application 131, according to example embodiments.

Referring to FIG. 1, the authoring tool 110 may generate 3D graphic data. Here, authoring may refer to the generating of data in various forms such as text, graphic data, digital image data, and the like, into a single piece of multimedia data. The authoring tool 110 may refer to a component suitable for, functional for, configured to, adapted to, or capable of generating the multimedia data. In an example embodiment, a user may generate a 3D object according to various types of information such as coordinate information and size information, using the authoring tool 110.

The shader IDE 120 may refer to a component suitable for, functional for, configured to, adapted to, or capable of performing various types of graphic processing with respect to the 3D graphic data received from the authoring tool 110. For example, shading refers to a work of applying a color to the 3D graphic data or expressing a surface characteristic. To perform the shading, various attributes of the 3D graphic data, such as a shape, a color impression, a texture, a pattern, and the like, need to be accurately identified and applied. A shader may refer to a component for expressing various effects such as the color impression, the texture, and the pattern, excluding the shape, of the 3D graphic data to implement the 3D object on a 2D computer screen. In addition, the shader may process various effects according to a user intention, using lighting information, texture information, and the like. In general, a plurality of shaders (e.g., tens of shaders) may be necessary to obtain a result of the 3D graphic data with respect to one scene. Each shader may include connected nodes like a network. The shader IDE 120 may provide the 3D application 131 with shader information and the 3D graphic data more efficiently. To be more specific, the 3D application may receive a shader file which includes the shader information such as a color impression and a pattern of the 3D graphic data from the shader, and receive an exported file which includes the 3D graphic data from the authoring tool 110. However, when the shader IDE 120 is used, the 3D application 131 may receive a data file and the shader file which include a material file and a graphic data file, from the shader IDE 120. Here, the graphic data file may include vertex information, texture information, animation information, and character information of the 3D graphic data.

The 3D application 131 may refer to an application program suitable for, functional for, configured to, adapted to, or capable of performing rendering with respect to the 3D graphic data, using the shader file and the data file received from the shader IDE 120. The 3D application 131 may be driven in a mobile device 130, particularly, in a graphic processing unit (GPU). The mobile device 130 may be any electronic device which is generally portable, for example, a laptop, mobile phone (e.g., a smart phone), a tablet computer, and the like. However, the disclosure is not so limited and other types of devices may correspond to the mobile device. Here, the GPU may refer to a processor including a single chip. The GPU may generate a 3D scene renewed every time, for example by a light source effect and transformation of an object. Thus, the 3D graphic data may be implemented in the mobile device 130 by the authoring tool 110, the shader IDE 120, and the 3D application 131.

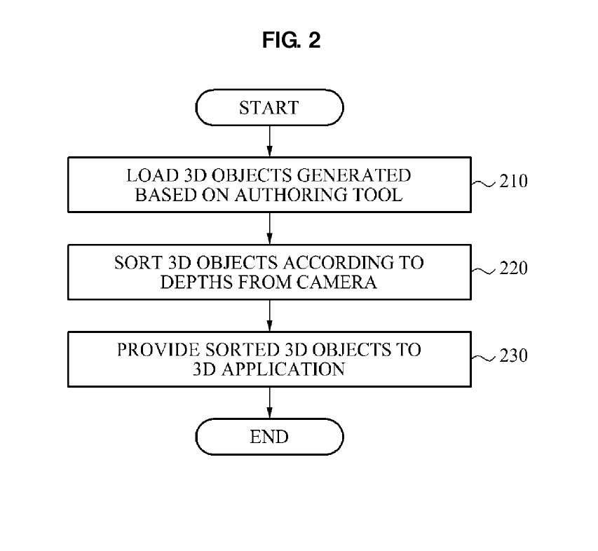

FIG. 2 illustrates an operational flow of a method of generating 3D graphic data of a shader IDE, according to example embodiments.

Referring to FIG. 2, the method of generating the 3D graphic data of the shader IDE, that is, the 3D graphic data generation method may load a plurality of 3D objects generated based on an authoring tool in operation 210. For example, in operation 210, a scene file stored in the shader IDE may be loaded. The scene file may be received from the authoring tool or generated using the plurality of 3D objects received from the authoring tool. Additionally, in operation 210, data elements of the plurality of 3D objects may be identified from the scene file. The data elements may include information on vertices, lines, and surfaces of the plurality of 3D objects, object identifiers (IDs), and data structures.

The 3D graphic data generation method may sort the plurality of 3D objects according to depths from a camera in operation 220. In detail, when the plurality of 3D objects are rendered in a render buffer in order of being drawn, the plurality of 3D objects may be rendered irrespective of proximity of the camera. In this case, since the depths from the camera of the plurality of 3D objects are not reflected, realistic 3D graphic data may not be provided to the user. Therefore, in operation 220, the plurality of 3D objects may be sorted by depth sorting. Here, when the depth sorting is performed in the 3D application, an amount of calculation of the 3D application may be increased, accordingly increasing a loading time of the 3D application. However, when the depth sorting is performed in the shader IDE as in operation 220, the 3D application may perform only loading of a result of the depth sorting without directly performing the depth sorting of the plurality of 3D objects. Consequently, the loading time may be reduced.

In further detail, in operation 220, object vertex medians of the plurality of 3D objects may be calculated based on the data elements. According to example embodiments, the object vertex medians may be calculated using the information on vertices, lines, and surfaces of the plurality of 3D objects, in operation 220. The object vertex medians may correspond to positions of the plurality of 3D objects. In addition, in operation 220, the object IDs, the data structures, and the object vertex medians included in the data elements may be associated.

Additionally, in operation 220, whether camera routes of the plurality of 3D objects are set may be determined. According to whether the camera routes are set, the plurality of 3D objects may be arranged according to the depths from the camera in operation 220.

For example, when the camera routes are set, camera positions of the plurality of 3D objects may be identified in operation 220. The camera positions may correspond to views of the user with respect to the plurality of 3D objects. Therefore, the camera positions may function as reference points for calculating the depths of the plurality of 3D objects. In addition, in operation 220, model views (MVs) of the plurality of 3D objects may be calculated based on the camera positions. Here, the MVs may indicate positions of fields of view to be shown on a display according to local positions of the plurality of 3D objects and the camera positions. In this case, according to example embodiments, the MVs may be calculated using a MV matrix.

In addition, in operation 220, depth information about the depths from the camera of the plurality of 3D objects may be extracted using the object vertex medians, the camera positions, and the MVs being associated. Specifically, in operation 220, the positions of the plurality of 3D objects may be identified through the associated object vertex medians, and the positions of the fields of view to be shown on the display may be identified using the camera positions and the MVs. Furthermore, in operation 220, the depth information of the plurality of 3D objects may be extracted using distances between the positions of the plurality of 3D objects and the positions of the views.

In operation 220, the plurality of 3D objects may be allocated to a queue according to the depths from the camera using the depth information. For example, when the depths increase in order of a first 3D object, a second 3D object, and a third 3D object, those three 3D objects may be stored in the queue in order of the first 3D object, the second 3D object, and the third 3D object. That is, 3D objects may be stored according to a depth value, and for example, 3D objects may be stored in an order from 3D objects having a least depth to 3D objects having a greatest depth. Accordingly, a loading speed of the 3D application may be increased.

Conversely, when the position routes are not set or when the camera is absent, the plurality of 3D objects may be provided to the 3D application without calculation of the depths from the camera of the plurality of 3D objects, in operation 220. However, according to example embodiments, when the camera routes are not set or when the camera is absent, the depths of the plurality of 3D objects may be calculated by setting random camera positions or by using predetermined camera positions, in operation 220. Accordingly, in operation 220, the plurality of 3D objects may be arranged according to the depths from the camera.

The method of generating 3D graphic data of the shader IDE may provide the plurality of 3D objects being sorted to the 3D application in operation 230. Here, the 3D application may refer to an application program driven in a mobile device and capable of, suitable for, functional for, configured to, or adapted to perform rendering with respect to the 3D graphic data.

In operation 230, information on the queue to which the plurality of 3D objects are allocated may be stored in a binary file. For example, source codes related to the plurality of 3D objects received from the authoring tool, the data elements of the plurality of 3D objects, shader information such as a color impression or pattern of the plurality of 3D objects, and the depth information of the plurality of 3D objects allocated to the queue may be generated in operation 230. The binary file may be generated by compiling the source codes in operation 230. Also, in operation 230, the binary file may be transmitted to the 3D application, thereby providing the sorted plurality of 3D objects to the 3D application.

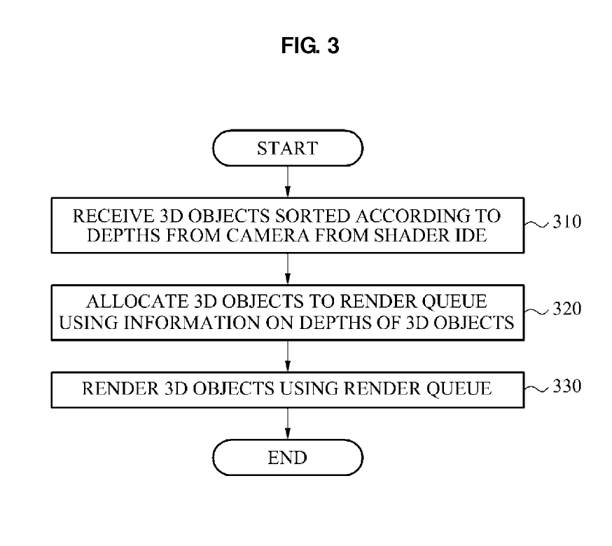

FIG. 3 illustrates an operational flow of a method of generating 3D graphic data of a 3D application, according to example embodiments.

Referring to FIG. 3, according to the 3D graphic data generation method according to the example embodiments, a plurality of 3D objects sorted according to depths from a camera may be received from a shader IDE in operation 310. For example, in operation 310, a binary file including depth information of the plurality of 3D objects may be received from the shader IDE. Here, the binary file may include information on the plurality of 3D objects, data elements of the plurality of 3D objects, shader information such as a color impression or pattern of the plurality of 3D objects, and information on depths of the plurality of 3D objects allocated to a queue. In addition, in operation 310, information on the queue to which the plurality of 3D objects are allocated according to depths from the camera may be extracted from the binary file. Here, since the plurality of 3D objects may be allocated to the queue in order of the depths from the camera, the queue may include information on the depths of the plurality of 3D objects from the camera.

The 3D graphic data generation method may allocate the plurality of 3D objects to a render queue using the information on the depths of the plurality of 3D objects in operation 320. The render queue may refer to a queue arranging the plurality of 3D objects in order of the depths of the plurality of 3D objects from the camera for improvement of performance of the 3D application. Accordingly, in operation 320, the plurality of 3D objects may be allocated to the render queue in order of the depths of the plurality of 3D objects from the camera. According to the example embodiments, the plurality of 3D objects may be allocated to the render queue using the queue to which the plurality of 3D objects received from the shader IDE are allocated according to the depths, in operation 320.

In operation 330, the plurality of 3D objects may be rendered using the render queue. For example, in operation 330, an embedded graphic library (EGL) may be initialized. The EGL refers to a common platform interface layer suitable for, functional for, configured to, adapted to, or capable of providing a graphic processing environment irrespective of a platform or an operation system (OS). In addition, in the operation 330, texture information and shader information may be received from the shader IDE. Accordingly, in operation 330, the plurality of 3D objects may be rendered using the plurality of 3D objects, data elements of the plurality of 3D objects, the texture information, the shader information, and the render queue, thereby providing the user with the 3D graphic data.

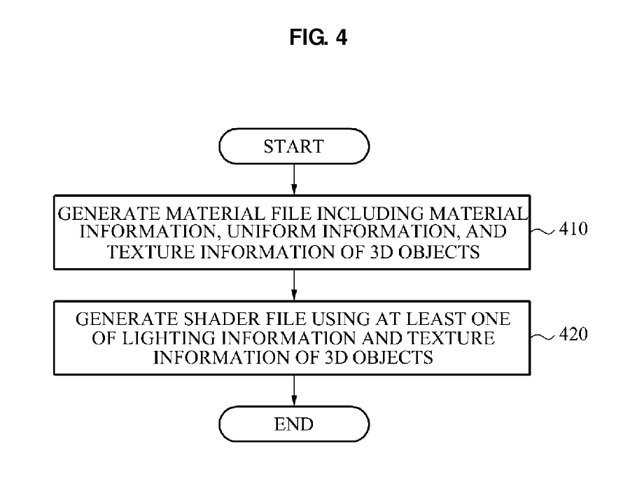

FIG. 4 illustrates an operational flow of a method of generating 3D graphic data of an authoring tool, according to example embodiments.

Referring to FIG. 4, the 3D graphic data generation method may generate a material file including material information, uniform information, and texture information of a plurality of 3D objects, in operation 410. For example, the authoring tool may generate the 3D graphic data. The 3D graphic data may include geometry data, texture data, animation data, and material data of a 3D object. The material information may be expressed using a material variable. The uniform information may be expressed using a uniform variable. The texture information may be expressed using a texture variable. In operation 410, an attribute variable, a matrix variable, a diffuse variable, and an ambient variable may be used to express various information. Accordingly, the shader IDE may generate the shader information and the 3D graphic data using the material file generated by the authoring tool. As a result, usability of the user (i.e., user convenience and/or user friendliness) may be increased.

In addition, the 3D graphic data generation method may generate a shader file using at least one of lighting information and the texture information of the plurality of 3D objects, in operation 420. Here, the shader file may include information for expressing various effects such as a color impression, a pattern, and the like with respect to the plurality of 3D objects. In example embodiments, when the lighting information and the texture information are both shaded to the 3D objects, the shader file may be generated by combining predetermined lighting information and texture shader information in operation 420. In other example embodiments, when the texture information is not shaded to the 3D objects, the shader file may be generated using simple color shader information in operation 420. That is, the texture information indicating texture is not shaded to the 3D objects but only color information is shaded. In still other example embodiments, when the lighting information is shaded without the texture information, the shader file may be generated using lighting color shader information in operation 420.

In addition, the 3D graphic data generation method may provide the material file and the shader file to the shader IDE. Accordingly, the shader IDE may use the material file and the shader file received from the authoring tool. As a result, usability of the user (i.e., user convenience and/or user friendliness) may be increased.

In addition, in example embodiments, the 3D graphic data generation method of the authoring tool may provide the material file and the shader file to the 3D application. In this case, the 3D application may receive the plurality of 3D objects, data elements of the plurality of 3D objects, the material file, and the shader file from the authoring tool, without using the shader IDE, and accordingly render the 3D graphic data.

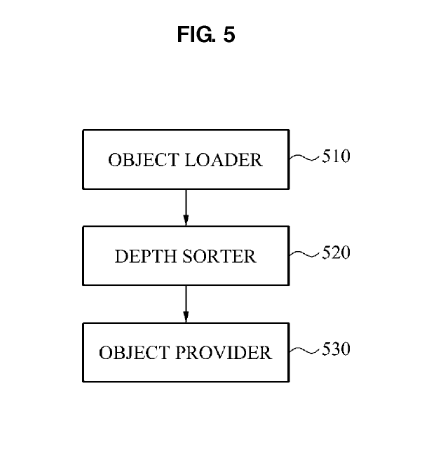

FIG. 5 illustrates a shader IDE according to example embodiments.

Referring to FIG. 5, an object loader 510 may load a plurality of 3D objects generated based on an authoring tool.

A depth sorter 520 may sort the plurality of 3D objects according to depths from a camera.

An object provider 530 may provide the sorted plurality of 3D objects to a 3D application.

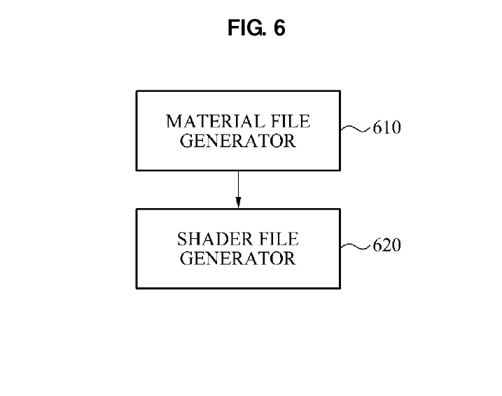

FIG. 6 illustrates an authoring tool according to example embodiments.

Referring to FIG. 6, a material file generator 610 may generate a material file including material information, uniform information, and texture information of a plurality of 3D objects.

A shader file generator 620 may generate a shader file using at least one of lighting information and the texture information of the plurality of 3D objects.

Since the description related to FIGS. 1 through 4 may be directly applied to the shader IDE of FIG. 5 and the authoring tool of FIG. 6, a detailed description will be omitted.

The apparatuses and methods according to the above-described example embodiments may use one or more processors. For example, a processing device may be implemented using one or more general-purpose or special purpose computers, such as, for example, a processor, an image processor, a controller and an arithmetic logic unit, a central processing unit (CPU), a graphics processing unit (GPU), a digital signal processor (DSP), a microcomputer, a field programmable array, a programmable logic unit, an application-specific integrated circuit (ASIC), a microprocessor or any other device capable of responding to and executing instructions in a defined manner.

One or more of the authoring tool, shader IDE, and mobile device may include or use a storage or memory to store data and files (e.g., a scene file, binary file, material file, shader file, and the like). For example, the storage may be embodied as a storage medium, such as a nonvolatile memory device, such as a Read Only Memory (ROM), Programmable Read Only Memory (PROM), Erasable Programmable Read Only Memory (EPROM), and flash memory, a USB drive, a volatile memory device such as a Random Access Memory (RAM), a hard disk, floppy disks, a blue-ray disk, or optical media such as CD ROM discs and DVDs, or combinations thereof. However, examples of the storage are not limited to the above description, and the storage may be realized by other various devices and structures as would be understood by those skilled in the art.

The terms “module”, and “unit,” as used herein, may refer to, but are not limited to, a software or hardware component or device, such as a Field Programmable Gate Array (FPGA) or Application Specific Integrated Circuit (ASIC), which performs certain tasks. A module or unit may be configured to reside on an addressable storage medium and configured to execute on one or more processors. Thus, a module or unit may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules/units may be combined into fewer components and modules/units or further separated into additional components and modules.

Each block of the flowchart illustrations may represent a unit, module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA).

Although example embodiments have been shown and described, it would be appreciated by those skilled in the art that changes may be made to these example embodiments without departing from the principles and spirit of the disclosure, the scope of which is defined in the claims and their equivalents.

What is claimed is:

1. A method for generating 3-dimensional (3D) graphic data of a shader integrated development environment (IDE), the method comprising:
loading a plurality of 3D objects generated based on an authoring tool;
sorting the plurality of 3D objects according to depths from a camera; and
providing the sorted plurality of 3D objects to a 3D application which is driven in a mobile device.

2. The method of claim 1, wherein the loading of the plurality of 3D objects comprises:
loading a scene file stored in the shader IDE; and
identifying data elements of the plurality of 3D objects from the scene file.

3. The method of claim 2, wherein the sorting of the plurality of 3D objects comprises:
calculating object vertex medians of the plurality of 3D objects based on the data elements; and
associating object identifiers (IDs) of the plurality of 3D objects included in the data elements and data structures with the object vertex medians.

4. The method of claim 3, further comprising:
determining whether camera routes of the plurality of 3D objects are set; and
arranging the plurality of 3D objects according to depths from a camera depending on whether the camera routes are set.

5. The method of claim 4, wherein, when the camera routes of the plurality of 3D objects are set, the arranging of the plurality of 3D objects comprises:
identifying camera positions of the plurality of 3D objects;
calculating model views (MV) of the plurality of 3D objects based on the camera positions;
extracting information on the depths from the camera for each of the plurality of 3D objects, using the object vertex medians, the camera positions, and the MVs being associated; and
allocating the plurality of 3D objects to a queue according to the depths from the camera using the information on the depths.

6. The method of claim 5, wherein the providing of the sorted plurality of 3D objects comprises:
storing information on the queue to which the plurality of 3D objects are allocated to a binary file; and
transmitting the binary file to the 3D application.

7. A method of generating 3-dimensional (3D) graphic data of a 3D application driven in a mobile device, the method comprising:
receiving a plurality of 3D objects sorted according to depths from a camera, from a shader integrated development environment (IDE);
allocating the plurality of 3D objects to a render queue using information on the depths from the camera; and
rendering the plurality of 3D objects using the render queue.

8. The method of claim 7, wherein the receiving of the plurality of 3D objects comprises:
receiving a binary file that includes information on the depths from the camera, from the shader IDE; and
extracting information on a queue to which the plurality of 3D objects are allocated according to the depths, from the binary file.

9. The method of claim 8, wherein the binary file further includes information on the plurality of 3D objects, data elements of the plurality of 3D objects, and shader information.

10. The method of claim 7, wherein the rendering further comprises:
initializing an embedded graphic library;
receiving texture information and shader information; and
rendering the plurality of 3D objects using the plurality of 3D objects, data elements of the plurality of 3D objects, the texture information, and the shader information.

11. A method of generating a 3-dimensional (3D) graphic data of an authoring tool, the method comprising:
generating, using a processor, a material file that includes material information, uniform information, and texture information of a plurality of 3D objects; and
generating a shader file using at least one of lighting information and the texture information of the plurality of 3D objects.

12. The method of claim 11, wherein the generating of the shader file further comprises:
generating the shader file by combining preset lighting information and texture shader information of the plurality of 3D objects.

13. The method of claim 11, wherein the generating of the shader file further comprises:
generating the shader file using simple color shader information.

14. The method of claim 11, wherein the generating of the shader further comprises:
generating the shader file using lighting color shader information.

15. The method of claim 11, further comprising:
providing the material file and the shader file to a shader integrated development environment (IDE).

16. The method of claim 11, further comprising:
providing the material file and the shader file to a 3D application driven in a mobile device.

17. A method of generating 3-dimensional (3D) graphic data of a 3D application driven in a mobile device, the method comprising:
receiving a plurality of 3D objects and depth information of the plurality of 3D objects, from a shader integrated development environment (IDE);
receiving, from at least one of the shader IDE and an authoring tool, a shader file including at least one of color impression and pattern information of the plurality of 3D objects;
receiving, from at least one of the shader IDE and the authoring tool, a material file including at least one of material information, uniform information, and texture information of the plurality of 3D objects; and
rendering the plurality of 3D objects in a predetermined order based on the depth information of the plurality of 3D objects, using information from the shader file and the material file.

18. The method of claim 17, wherein the material file is received from the authoring tool and the shader file is received from the shader IDE.

19. The method of claim 17, wherein the material file and the shader file are received from the shader IDE.
